(19) United States
(12) Patent Application Publication
(10) Pub. No.: US 2008/0210828 A1
(43) Pub. Date: Sep. 4, 2008

(54) Apparatus for holding wire harness

(75) Inventors: Naoto Kogure, Susono-shi (JP); Hisashi Takemoto, Sunono-shi (JP)

Correspondence Address: Edwards Angell Palmer & Doge LLP, P.O.Box 55874, Boston, MA, 02205, US

(73) Assignee: Yazaki Corporation, Tokyo (JP)

(21) Appl. No.: 12/010,478

(22) Filed: Jan. 25, 2008

(30) Foreign Application Priority Data
Mar. 1, 2007 (JP) 2007-051920

(51) Int. Cl. F16L 3/08

(52) U.S. Cl. 248/65

(57) ABSTRACT

The present invention is to provide an apparatus for holding a wire harness. The apparatus includes a case and a holder assembly disposed inside the case. The holder assembly includes a first, a second, and a third holder. One end of the first holder is pivotally attached to a main body and another end thereof is connected with the second holder with a first hinge. The second holder is pivotally connected with the third holder with a second hinge. The wire harness is flexibly passed through the holder assembly. The wire harness is flexural between the first and the second holder, and between the second and the third holder. The apparatus reduces a required length of the wire harness and improves bending endurance thereof.

### BACKGROUND OF THE INVENTION

1. Field of the Invention

The present invention relates to an apparatus for flexibly holding a wire harness, which is disposed in a sliding door of a motor vehicle, with a holder assembly so that an excess portion of the wire harness can be received in the sliding door.

2. Description of the Related Art

FIGS. 5 and 6 show a conventional apparatus for holding a wire harness (JP, 2001-354085, A, FIGS. 4 and 7).

The apparatus 50 is disposed on a sliding door 41 of a motor vehicle and includes a case 42 (protector), which is made of a synthetic resin and flexibly receives a wire harness 43, and a metal leaf spring 44 upwardly urging the wire harness 43 in the case 42.

The case 42 includes a base 42 (the same reference numeral as the case) and a cover (not shown). The base 42 and the cover each have a base plate 51 and a circumferential wall 52. The cover is locked to the base 42 with a locking means. The base 42 is fixed to a panel of the sliding door 41 with a bolt 56 or a locking clip. The base plate 51 includes an annular portion 54 to control flexion curvature of the wire harness 43 or the leaf spring 44.

A lower end portion of the leaf spring 44 is fixed to a fixing portion 55 together with the wire harness 43. A synthetic resin cap of another end portion of the leaf spring 44 stably supports the wire harness 43.

The wire harness 43 includes a plurality of insulated electrical wires 43a and a corrugated tube 43b. A forward and lower end portion of the corrugated tube 43 is fixed to the fixing portion 55 with a tape. The corrugated tube 43b has alternating annular recesses and ridges in a longitudinal direction and is flexible.

The electrical wires 43a of one end portion of the wire harness 43 are guided out of a forward portion of the case 42 and connected with auxiliaries of the sliding door 41. The corrugated tube 43b of the wire harness 43 is swingably guided to a fixing element 53 through a lower opening 45 of the case 42 and a stepping space 46 (FIG. 6), and connected with a wire harness (not shown) disposed on a main body 47 of the motor vehicle via the fixing element 53. The case 42 is covered with a door trim (not shown) and the wire harness 43 is guided to the main body through a lower opening of the door trim.

FIGS. 5 and 6 show the sliding door 41 fully closed and fully opened, respectively. When the sliding door 41 is fully closed, the wire harness 43 is backwardly pulled with the fixing element 53. When the sliding door 41 is fully opened, the wire harness 43 is forwardly pulled and bent around the annular portion 45. The annular portion 54 controls the minimum radius of the wire harness 43 and the leaf spring 44 and prevents excessive deformation of the leaf spring 44.

When the sliding door 41 is partly opened, the wire harness 43 tends to downwardly slack. The leaf spring 44, however, upwardly urges the wire harness 43 and prevents pinching of the wire harness 43 between the sliding door 41 and the main body 47. When the sliding door 41 is opened, the sliding door 41 departs from the main body 47 along a guide rail (not shown) of the main body 47.

JP, 2001-354085, A discloses that:the apparatus 50 can be horizontally disposed on the main body 47 instead of the sliding door 41.

FIG. 7 shows another conventional apparatus for holding a wire harness (JP, 2001-301545, A).

The apparatus 61 includes a guide rail 62 horizontally disposed on a sliding door 41, a slider 63 slidably engaging with the guide rail 62, links 64 and 65, one end of the link 64 and one end of the link 65 being pivotally connected with the slider 63 and the sliding door 41, respectively, and a short arm 66 horizontally rotatably connected with the slider 63.

A wire harness 67 is arranged along the links 65, 64 and guided to a fixing element 68 of a main body via the arm 66.

As the sliding door 41 is opened and closed, the guide rail 62 moves with respect to the slider 63 so as to swing the links 64 and 65 with the wire harness 67 as illustrated by a chained line.

The conventional apparatus 50 of FIG. 5 has several drawbacks. The apparatus 50 utilizes the expensive leaf spring 44, resulting in increase cost of manufacturing. The structure that the leaf spring 44 upwardly urges the case 42 to adjust the excess portion of the wire harness 43 requires an increasing height of the case 42. The wire harness 43 is flexibly arranged along the leaf spring 44 and thus the length thereof becomes long, resulting in a large size and high cost structure.

The conventional apparatus 61 of FIG. 7 has also several drawbacks. The apparatus 61 requires a large space to rotate the links 64 and 65 and to dispose the guide rail 62. Arrangement of other parts or the auxiliaries in the sliding door is restricted. Arrangement of the links 64, 65, the guide rail 62, the slider 63, and the arm 66 increase weight, complication, and manufacturing cost. The wire harness 67 is bent with a small radius at a junction between the links 64 and 65, and a junction between the link 64 and the arm 66, resulting in reducing endurance of the wire harness 67.

### SUMMARY OF THE INVENTION

An object of the present invention is to provide an apparatus for holding a wire harness, the apparatus including a short wire harness and providing high endurance of the wire harness with low manufacturing cost.

According to a first object of the present invention, an apparatus for holding a wire harness includes a holder assembly; wherein the holder assembly includes a first holder, a second holder, and a third holder, one end of the first holder is pivotally attached to a main body, another end thereof is connected with the second holder with a first hinge, and the second holder is pivotally connected with the third holder with a second hinge, wherein the wire harness is flexibly passed through from the first, the second, and the third holder, and wherein the first and the second holder are pivotal in opposite directions each other about the first hinge, and the second and the third holder are pivotal in opposite directions each other about the second hinge to accept swingable movement of the wire harness and to receive an excess portion of the wire harness inside the case.

Preferably, the wire harness is flexural between the first and the second holder, and between the second and the third holder.

Preferably, the first holder is urged with a resilient member in a direction to receive the excess portion of the wire harness.

Preferably, the first, the second and the third holder are protectors to protect the wire harness, which is flexural around the first and the second hinge.

### BRIEF DESCRIPTION OF THE DRAWINGS

FIG. 1 is a front view of a first embodiment of an apparatus for holding a wire harness of the present invention with a sliding door fully closed;

FIG. 2 is a front view of the apparatus with the sliding door partly opened;

FIG. 3 is a front view of the apparatus with the sliding door fully opened;

FIG. 4A is a perspective view of an embodiment of a holder assembly of the apparatus;

FIG. 4B is a front view of the holder assembly;

FIG. 5 is a perspective view of a conventional apparatus for holding a wire harness with a sliding door fully closed;

FIG. 6 is a perspective view showing the sliding door almost fully opened; and

FIG. 7 is a front view of another conventional apparatus for holding a wire harness.

### DETAILED DESCRIPTION OF THE PREFERRED EMBODIMENTS

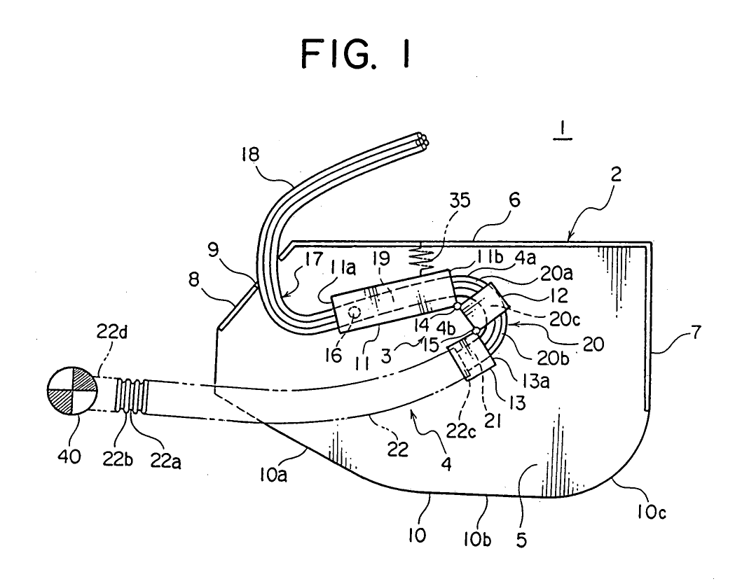

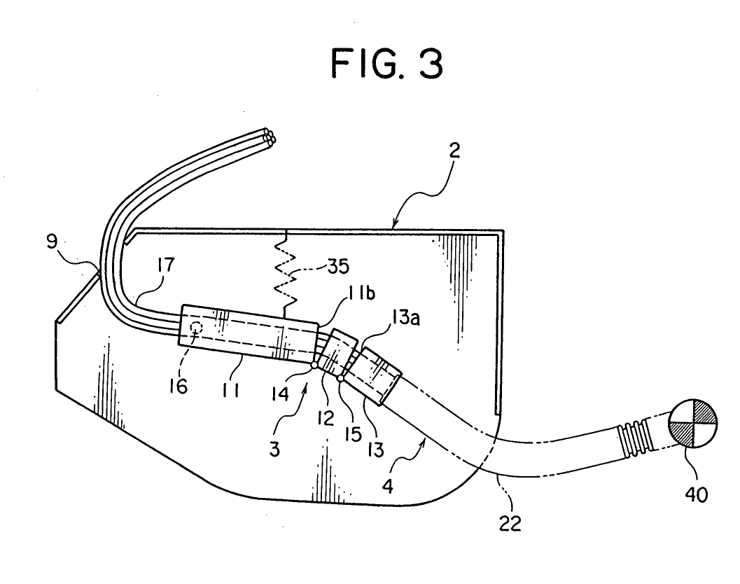

FIGS. 1-3 are an embodiment of an apparatus for holding a wire harness.

The apparatus 1 is vertically mounted on a sliding door (sliding configuration) of the left side of a motor vehicle. FIGS. 1-3 show the sliding door of the motor vehicle fully closed, partly opened, and fully opened, respectively.

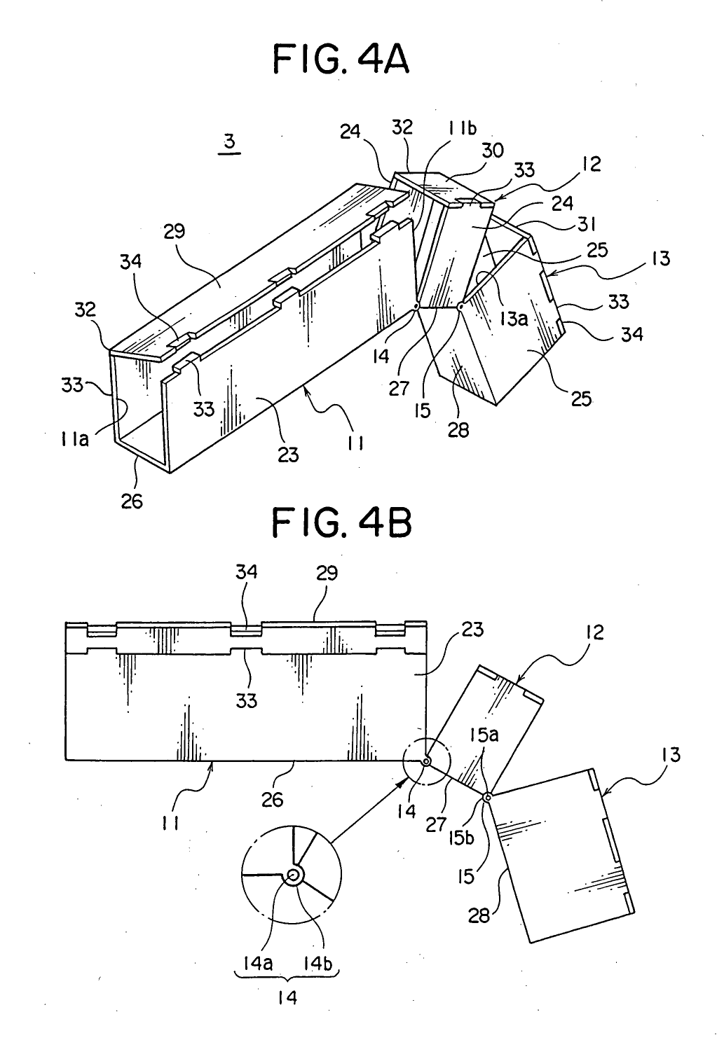

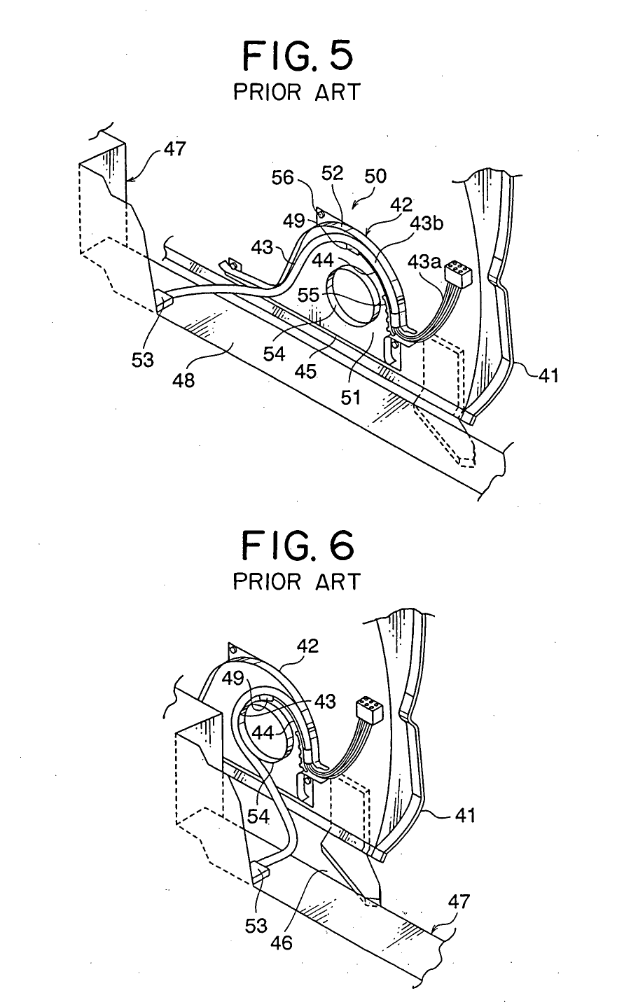

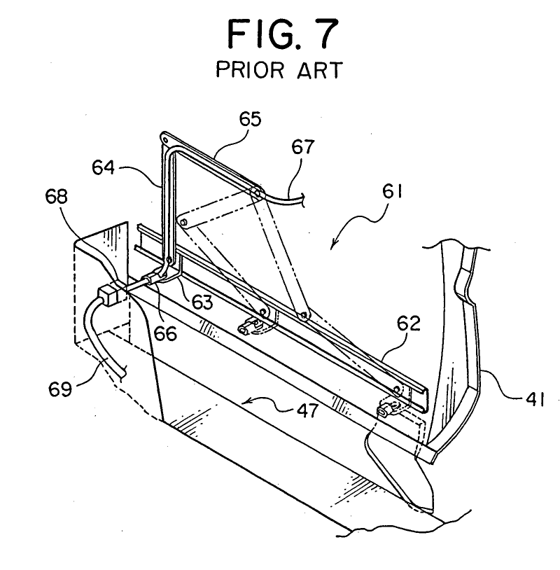

Referring to FIG. 1, the apparatus 1 includes a case (protector) 2 made of a synthetic resin, a holder assembly 3 made of a synthetic resin and disposed on the case 2, one end of the holder assembly 3 being pivotally supported with an axle 16 (support portion), and a wire harness 4 flexibly arranged along the holder assembly 3 in the case 2. The holder assembly 3 is explained below by referring to FIGS. 4A and 4B.

The case 2 is smaller than the conventional case 42 and includes a base 2 (the same numeral as the case is used) and a cover (not shown). The case 2 has opposed base plates 5 and a circumferential wall including an upper wall 6, a front wall 7, and an inclined rear wall 8. The circumferential wall is only exemplary. The case 2 includes a narrow opening 9 in the rear wall 8 to guide the wire harness 4 and an elongated opening 10 at a lower portion of the case 2 to guide the wire harness 4.

Lower edges of the base plates 5 of the base 2 and the cover each have an inclined portion 10a, a horizontal portion 10b, and a circular portion 10c. It is preferable that the lower edge of the cover has an outwardly extending guide surface for the wire harness 4.

The wire harness 4 is fixed at the opening 9 with a band or a tape, flexibly arranged along the holder assembly 3, and guided out of the lower opening 10 toward a fixing element (not shown) of a main body of a vehicle. Reference numeral 40 indicates a cross section of the wire harness 4. The wire harness 4 is slidably back-and-forth guided out of the lower opening 10. Forward and backward, upward and downward, and leftward and rightward directions in the specification coincide with directions viewed from a driver of the vehicle.

The holder assembly 3 includes a first, a second, and a third holder 11, 12, 13, and a first and a second hinge 14, 15 to interconnect the holders 11 and 12, and 12 and 13 each other, respectively. The first holder 11 and the second holder 12 are connected with the first hinge 14, and the second holder 12 and the third holder 13 are pivotally connected with the second hinge 15.

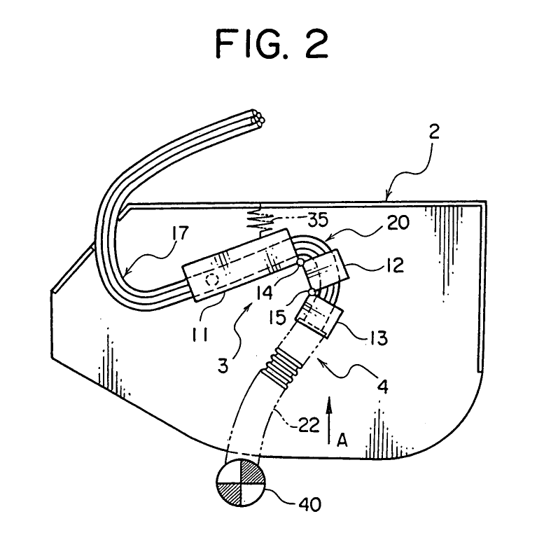

The first holder 11 and the second holder 12 are pivotal about the first hinge 14 in opposite directions each other. The second holder 12 and the third holder 13 are also pivotal about the second hinge 15 in opposite directions each other. The pivoting of the holders 11-13 about the hinges 14 and 15 function to receive an excess portion of the wire harness 4 in a direction indicated by A in the case 2 (FIG. 2). The wire harness 4 is flexibly bending at the first hinge 14 and the second hinge 15. An outer surface of the bending potion of the wire harness 4 is referred to 4a as a reference sign. An inner surface thereof 4 facing the hinges 14, 15 is referred to 4b as a reference sign.

The first holder 11 is longest among the holders 11-13 and pivotally (slidably) supported with the axle 16 at the one end thereof along the vertical base plates 5 of the case 2.

When the sliding door is fully closed (FIG. 1), the holder assembly 3 is arranged in a fallen U-shape such that the first holder 11 is forwardly upwardly sloped, the second holder 12 is forwardly inclined, and the third holder 13 is turned over with respect to the first holder 11 and backwardly inclined.

A plurality of electrical wires 17 of the wire harness 4 are guided into the case 2 from the upper opening 9 and upwardly forwardly guided in through opening 11a and out of opening 11b of the first holder 11 as an inclined wire harness portion 19. The electrical wires are guided into the third holder 13 via the second holder 12. The electrical wires 17 form a bending portion 20 including an upper bending portion 20a, a lower bending portion 20b, and a straight portion 20c between the bending portions 20a and 20b. The electrical wires 17 positioned in the third holder 13 and designated as 21 are guided into a corrugated tube 22. The electrical wires 17 guided with the corrugated tube 22 are connected to a fixing element of the main body of the vehicle. The fixing element is connected with a wire harness (not shown) of the main body. The electrical wires 17 guided out of the opening 9 and designated as 18 are connected to auxiliaries or a wire harness (not shown) of the sliding door.

The corrugated tube 22 includes alternating annular valleys 22a and ridges 22b in the longitudinal direction thereof and has an oval section (flat type). One end 22c of the corrugated tube 22 is connected with one end of the third holder 13 and another end 22d thereof is fixed or axially rotatably supported with the fixing element.

Referring to FIGS. 4A and 4B, the holder assembly 3 includes the first, the second, and the third holder 11-13, and the first and the second hinge 14, 15. The holders 11-13 have a rectangular cylinder shape. The holders 11-13 include opposed side walls 23-25, bottom walls 26-28, and cover walls 29-31, respectively. Ends of the cover walls 29-31 are openably connected to the one side walls 23 with hinges 32 and another ends thereof are locked to the another side walls 23 with locking recesses 34 and locking claws 33. The locking means such as the claws 33 and the recesses 34 is suitably designed if necessary. The holders 11-13 correspond to a conventional harness protector made of a synthetic resin and having the rectangular cylinder shape.

The bottom walls 26, 27 and the bottom walls 27, 28 are connected with the first hinge 14 and the second hinge 15, respectively. The hinges 14, 15 include axles 14a, 15a and annular axle bearings 14b, 15b. For example, the second holder 12 includes the axles 14a, 15a at rear and front ends thereof. The axle bearings 14b, 15b are disposed on a front end of the first holder 11 and a rear end of the third holder 13, respectively.

The end portion of the corrugated tube 22 can be fixed to the front end portion of the third holder 13 with the tape. The electrical wires 17 of the wire harness 4 are flexibly arranged through the three holders 11-13.

The opposed base plates 5 of the case 2 have gaps with respect to the opposed side walls 23-25 of the holders 11-13 to allow slidable movement of the holders 11-13 within the case 2. The holders 11-13 prevent twisting of the wire harness 4, and allow smooth and flexible swing of the wire harness 4.

FIGS. 4A and 4B do not show the axle 16 pivotally supporting the first holder 11 as depicted in FIG. 1. The first holder 11 can be supported with the axle 16, which projects from the base plate 5 of the base 2, passes a hole (not shown) of the one side wall 23 and is retained with a C-ring (not shown). It is also appreciated that the axle 16 projects from the side wall 23 of the first holder 11, passes a hole (not shown) of the base plate 5 and is retained with the C-ring. The first holder 11 can be supported with a locking clip and a hole (both not shown) engaging with the locking clip disposed on the side wall 23 and the base plate 5, respectively, or vice versa.

It is apparent that the first and the second hinge 14 and 15 are disposed on a lower portion of the holder assembly 3 to flexibly receive the excess portion of the wire harness 4.

The excess portion of the wire harness 4 can be effectively received with use of a resilient member such as an extension coil spring 35.

The extension coil spring 35 upwardly supports a front end portion of the first holder 11 as shown in FIG. 1. An upper end of the coil spring 35 and a lower end thereof are fixed to the upper wall 6 of the case 2 and the cover wall 29 of the first holder 11. The extension coil spring 35 generates a force to upwardly pull and rotate the first holder 11 about the axle 16 when the extension coil spring 35 is stretched.

As shown in FIG. 1, the electrical wires 17 are flexibly bending at the second holder 12 such that a straight portion 20c of the electrical wires 17 is supported with the second holder 12 and the bending portions 20a and 20b are positioned both sides of the second holder 12 to form the bending portion 20 of a large radius and thus avoid concentration of flexural stress of the electrical wires 17.

The radius of the bending portion 20 of the electrical wires 17 can be adjusted by changing a length of the second holder 12. The longer length of the second holder 12 further reduces the bending stress on the electrical wires 17.

When the sliding door is fully closed, the corrugated tube 22 is backwardly pulled with the fixing element disposed on the main body of the vehicle. The electrical wires 17 of the wire harness 4 are then arranged in a leftwardly fallen U-shaped manner. The electrical wires 17 guided out of the front opening 11b of the first holder 11 are positioned to the highest position 4a.

When the sliding door is partly opened, the sliding door is outwardly spaced-apart with the case 2 from the main body of the vehicle.

The case 2 is positioned closest to the fixing element of the main body. The corrugated tube 22 rigidly maintains the shape of the holder assembly 3 almost similar to that of the holder assembly 3 of FIG. 1 (the door is fully closed). The corrugated tube 22 and the excess portion of the wire harness 4 are thus received inside the case 2.

This function can be achieved without the extension coil spring 35. The extension coil spring 35 upwardly urges the holder assembly 3 and thus assuredly prevents the wire harness 4 from slacking due to its own weight when the sliding door is partly opened.

As the corrugated tube 22 swings to the central portion of the case 2, the electrical wires 17 change the bending shape from the fallen U-shape to an inclined lambda-shape as shown in FIG. 2. The third holder 13 swings counterclockwise from the position in FIG. 1.

When the sliding door is further opened, the wire harness 4 is forwardly pulled with the fixing element and the first holder 11 pivots clockwise about the axle 16. The first holder 11 downwardly pivots against the extension coil spring 35 and the openings 11b and 13a of the holders 11 and 13 are closed with stretching of the holder assembly 3 when fully opened.

The wire harness 4 extends almost straight from the axle 16 to the fixing element of the main body. This configuration reduces the required length of the wire harness 4 and thus decreases weight and cost of the wire harness 4. The shorter length of the wire harness 4 attains a smaller space and size of the case 2.

When the sliding door is partly closed from the fully opened state, the corrugated tube 22 backwardly swings and upwardly moves the first holder 11 by virtue of rigidity thereof and upwardly moves the wire harness 4. The extension coil spring 35 assists upward movement of the first holder 11 if the extension coil spring 35 is disposed.

When the sliding door of FIG. 2 is further forwardly slid, the inclined position of the first holder 11 is maintained and the corrugated tube 22 is backwardly pulled with the fixing element. The third holder 13 rotates clockwise about the hinge 15 as depicted in FIG. 1.

The present invention discloses the first embodiment, which does not utilize the extension coil spring 35, and the second embodiment, which utilizes the extension coil spring 35. The extension coil spring 35 can be replaced with a wave-shaped leaf spring (not shown). The extension coil spring 35 can be replaced with a flat leaf spring (not shown), an end portion of which is supported with the axle 16. The extension coil spring 35 can be replaced with a compression coil spring (not shown) disposed on a lower side of the first holder 11.

The rectangular cylinder of the holders 11-13 can be replaced with a circular cylinder. The holders 11-13 can be replaced with plates (links) interconnected with hinges having axles, holes and stoppers. The electrical wires 17 are held on the plates with a tape or a band. The stoppers function the hinges to operate same as those of the holder assembly 3 of FIGS. 4A and 4B.

The corrugated tube 22 can be replaced with a net tube as the protection tube. It is possible to remove the protection tube and the electrical wires are bound with the tape or the band.

The three holders 11-13 can be replaced with four holders. A second and a third holder form a bending portion 20 with a radius larger than the embodiment. The embodiment of the present invention discloses the first holder 11 having the longest length. Length of the holders can be adjusted if necessary.

It is appreciated that the case 2 of FIG. 1 can be turned over about a vertical axis.

It is appreciated that the case 2 can be disposed on the main body of the vehicle. The case 2 can also be disposed horizontally or a slope on the sliding door or the main body.

The case 2 of the present invention protects the holder assembly 3 and the bending portion 20 of the wire harness 4 from external interference. The holder assembly 3 or the links can be pivotally attached directly to a door inner panel or a door trim of the sliding door without the case 2.

The embodiments of the apparatus 1 for holding the wire harness are also adapted to a sliding body such as a sliding door of a vehicle other than the motor vehicle or a sliding door of a manufacturing apparatus or a testing apparatus.

What is claimed is:

1. An apparatus for holding a wire harness comprising a holder assembly,
wherein the holder assembly includes a first holder, a second holder, and a third holder, one end of the first holder is pivotally attached to a main body, another end thereof is connected with the second holder with a first hinge, and the second holder is pivotally connected with the third holder with a second hinge,
wherein the wire harness is flexibly passed through from the first, the second, and the third holder, and
wherein the first and the second holder are pivotal in opposite directions each other about the first hinge, and the second and the third holder are pivotal in opposite directions each other about the second hinge to accept swingable movement of the wire harness and to receive an excess portion of the wire harness inside the case.

2. The apparatus as claimed in claim 1, wherein the wire harness is flexural between the first and the second holder, and between the second and the third holder.

3. The apparatus as claimed in claim 1, wherein the first holder is urged with a resilient member in a direction to receive the excess portion of the wire harness.

4. The apparatus as claimed in claim 1, wherein the first, the second and the third holder are protectors to protect the wire harness, which is flexural around the first and the second hinge.
